(19) United States
(12) Patent Application Publication
(10) Pub. No.: US 2004/0144860 A1
(43) Pub. Date: Jul. 29, 2004

(54) Concentric paint atomizer shaping air rings

(76) Inventors: Hans Jurgen Nolte, Stuttgart (DE); Harry Crumma, Bonnigheim (DE); Martquardt, Stuttgart (DE)

Correspondence Address: Gregory D. DeGrazia, Suite #101, The Pinehurst Office Center, 39400 North Woodward Avenue, Bloomfield Hills, MI, 48304-5151, US

(21) Appl. No.: 10/713,910

(22) Filed: Jan. 24, 2003

(51) Int. Cl. B05B 1/28

(52) U.S. Cl. 239/290

(57) ABSTRACT

Two steering air currents that can be controlled independently of one another are directed onto the atomizing cone from the steering air ring of an atomizer for the series coating of workpieces, e.g., car bodies, wherein said steering air currents emerge at different radial distances from the atomizer axis and serve to adjust the width of the spray jet in different regions, such that the spray jet of one and the same atomizer can be optimally adapted to the respective workpiece region to be coated.

The invention pertains to a method for controlling the width of the spray jet of an atomizer and to an atomizer, for the series coating of workpieces, which comprises outlet openings for producing a gas current that bounds the atomizing cone according to the preambles of the independent claims.

The invention specifically pertains to the control of steering air in electrostatic rotary atomizers as they are conventionally utilized for the series coating of workpieces, e.g., car bodies. However, the invention can also be utilized in other types of atomizers. The invention is suitable for arbitrary coating materials, including coating liquids and coating powders.

In conventional rotary atomizers (DE 4306800), the steering air is directed from the atomizer onto the conical outer surface of the bell, wherein this steering air not only provides the coating particles that are radially expelled at the edge of the bell dish with an additional impetus in the direction of the workpiece, but it also serves to form the spray jet, and in part, to assist in the atomizing process. The steering air emerges from a circle of holes in the end face of a steering air ring arranged on the front end of the atomizer housing. The number, diameter, shape and direction of the holes may be chosen differently in order to optimize the air speed, the air quantity and the width of the spray jet. The respective steering air quantity that defines the desired spraying width is predetermined in the form of a parameter of the coating process, and is controlled in a closed control loop.

Arrangements of outlet openings in the form of annular slits can be provided for the steering air, instead of holes. In the rotary atomizer known from EP 0092043, an outer annular slit is provided in addition to a radially inner annular slit, wherein this outer annular slit is supplied with compressed air by the same source as the inner annular slit. The width of one or both annular slits is adjustable. The outer air curtain produced by the additional annular slit has the function of compensating for the marginal turbulence produced by the coating substance cloud in interaction with the inner air current, and of returning escaped coating particles back into the cloud.

In other rotary atomizers, radially outer auxiliary outlet openings for air are provided in addition to the radially inner air openings, wherein the air emerging from the auxiliary outlet openings is intended to prevent the coating particles from returning into the atomizer.

One general problem in the utilization of atomizers is that atomizing cones of different widths are required for coating different workpiece regions. Known high-speed rotary atomizer systems, for example, for coating car bodies, are preferably designed in such a way that, when coating large areas, bell dishes with a larger diameter are used and the width of the spray jet (defined as SB 50%, i.e., as the width at 50% of the maximum layer thickness of the individual profile) is adjusted to a value of approximately 300-550 mm. Smaller bell dishes are used for detail coating and interior coating processes, as well as for coating attachments and other small components such as mirrors, decorative strips and shock absorbers, where the width of the spray jet is usually adjusted to a value between 180-300 mm. When using smaller or narrower spraying patterns, the application efficiency, which is defined as the ratio between the coating material that is sprayed and the coating material that is precipitated, is higher than when using wider spraying patterns. This makes it possible to significantly reduce the costs, as well as the consumption of coating material.

EP 1114677 discloses an atomizer with exchangeable bells that differ from one another with respect to their diameter, spraying direction, and steering air quantity. The appropriate bell is chosen as a function of the shape of the object to be coated and the color used, etc. For example, a bell with a large diameter is used for exterior surfaces, and a bell with a smaller diameter is used for interior surfaces of car bodies.

If the coating process cannot be interrupted in order to replace the spraying head, high efficiency and a uniform coating layer can be achieved only by comprehensive coating of a workpiece with wide and narrow spray jet adjustments. Since it is not possible to adjust the spray jet to a sufficiently small size, it is necessary to make compromises with respect to the efficiency, the consumption of coating material, and the color shade, between the bell dish size with the corresponding steering air supply, and the jet width. Although superior constriction of the spray jet can be achieved by reducing the rotational speed, this results in a reduced atomizing fineness and deterioration of the coating quality. Until now, it has not been possible to optimally adjust the spray jet to both of the above-mentioned widths with the steering air of a given atomizer. This resulted in significant disadvantages in practical applications, for example, insufficient or impossible interior or detail coating processes, increased overspray (the portion of coating material sprayed past the object), low application efficiency, increased consumption of coating material, and insufficient coating quality.

The invention is based on the objective of eliminating these disadvantages and of disclosing a method and an atomizer which respectively make it possible to adjust the width of the spray jet within a significantly broader range than has thus far been possible, namely without having to replace the spraying head or mechanically change the outlet opening arrangement, and while still ensuring an optimal coating process with superior application efficiency and coating quality.

This objective is attained with the characteristics disclosed in the claims.

The at least two steering air currents (or other gas currents used for the same purpose) that are controlled in a closed control loop are normally not generated simultaneously, but rather are used selectively depending on the workpieces or workpiece regions to be coated. However, it would also be conceivable to simultaneously utilize steering air currents that can be controlled independently of one another.

The invention makes it possible to carry out comprehensive coating processes including interior, exterior and detail coating processes on complex workpiece geometries and, in particular, entire car bodies with one and the same rotary atomizer. In this case, the application efficiency is maximized because the spray jet width can be precisely adjusted within the entire required range. The utilization of two steering air currents that can be controlled independently of one another makes it possible to adapt the width of the spray jet to each object to be coated in an optimal fashion.

This optimally adjusted spray jet results in less overspray, such that the application efficiency is improved and the consumption of coating material is reduced. This optimization simultaneously improves the coating quality.

The invention is described in greater detail below with reference to the embodiment that is illustrated in the figures. The figures show:

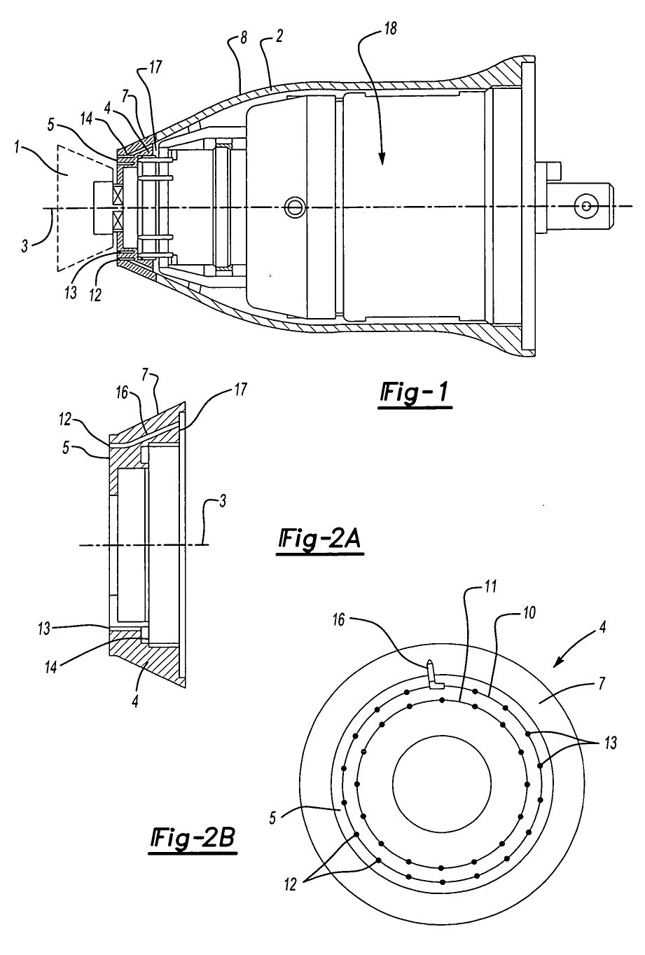

FIG. 1, a rotary atomizer with a steering air ring according to the invention;

FIG. 2a, a section through the steering air ring of the atomizer, and

FIG. 2b, a top view of the steering air ring of FIG. 2a that is viewed from the left.

With the exception of the described steering air control of the spray jet, the electrostatic rotary atomizer shown in FIG. 1 can correspond to the prior art, e.g., the above-mentioned DE 4306800. A steering air ring 4 is conventionally arranged coaxial to the atomizer axis 3 on the end face of the atomizer housing 2 that faces the bell dish 1. The holes 12, 13 for the steering air that serve to adjust the width of the spray jet and are described below end in the radially extending end face 5 of the steering air ring 4 that faces the bell dish 1 and consequently the atomizing cone formed by the sprayed coating material. The peripheral surface 7 of the annular body 4 conically widens downward as shown in the figure, and is aligned flush with the adjacent peripheral surface 8 of the housing 2. Air turbulence around the atomizer is prevented due to the uninterrupted and smooth outer contour of the entire atomizer periphery, wherein undesired influence of the spraying process on the bell dish 1 as well as contamination of the atomizer housing are prevented.

The end face 5 of the steering air ring 4 can be situated axially behind the bell dish 1 as in the embodiment shown, wherein this end face can extend radially inward into the vicinity of the hollow shaft of the air turbine that drives the bell dish. The steering air ring could also be completely inserted into the open end face of the atomizer housing. In another embodiment, the steering air ring with its arrangement of the outlet openings projects axially forward over the bell dish.

FIG. 2a and FIG. 2b show the steering air ring 4 in greater detail. Two rings of steering air holes 12 and 13 at equal distances apart forming concentric partial circles 10 and 11 with different diameters that are arranged concentric to the atomizer axis 3 (FIG. 1), and consequently also to the atomizing cone axis, terminate in end face 5.

In the embodiment shown, the holes 12 and 13 are respectively arranged in the end face in an axially parallel fashion. However, it is possible to realize other arrangements. The radially inner holes 13 are supplied by an annular channel 14 within the steering air ring 4 which is connected to a (not-shown) compressed air line of the atomizer. The outer holes 12 of the steering air ring 4 first run axially from the end face 5 and then, as shown in the figure, with rear part 16 run approximately parallel to the peripheral surface 7 radiating out to annular channel 17. The latter annular channel is, after installing the steering air ring, formed between the rear side of the steering air ring and the adjacent parts of the atomizer, wherein this annular channel is supplied by another compressed air line of the atomizer.

Instead of utilizing two circles of holes 12 and 13, it would also be conceivable to provide outlet opening arrangements in the form of annular slits in a steering air ring or, if applicable, in separate components of the atomizer.

The two aforementioned compressed air lines may, for example, each be connected to a compressed air connection of the atomizer for external lines, each of which can lead to its own air control system. For example, if the expenditure for two separate air controllers is unjustifiably high, the compressed air lines can also be connected to a common air control system for the holes 12 and 13 by means of a reversing valve that is controlled as a function of the respective workpiece region to be coated. The reversing valve does not necessarily have to be situated outside the atomizer, but can also be installed in the atomizer, for example, in the valve unit 18, such that only one external steering air connection is required. It would also be conceivable to control the steering air within the atomizer.

When coating workpieces, e.g., car bodies, the first controlled steering air emerging from the radially inner holes 13 is preferably used for adjusting wide spray jets (for example, SB 50% of 250-300 mm) for the exterior coating process. In this case, the second steering air, which is controlled separately from the first steering air and emerges from the holes 12 in the larger graduated circle 10, is used for adjusting narrower spray jets (for example, SB 50% of 50-300 mm) for detail and interior coating processes, wherein it may be practical for both regions to overlap (as in the described example). This means that the width of the spray jet can be adjusted within the entire range required for the exterior, interior and detail coating processes (50-550 mm in the described example) with one and the same atomizer, without having to interrupt the coating process and without having to accept significant disadvantages. The two steering air currents can be used and controlled independently of one another, i.e., one steering air can be switched off while the atomizer operates with the other steering air. The first steering air that emerges from the inner holes 13 behind the bell dish 1 impacts the conically downward tapered peripheral surface of the bell dish 1 relatively far toward the rear, wherein an air cushion is generated around the bell dish and a uniform air distribution is advantageously achieved during atomization. The second steering air emerging from the outer holes 12 can, by contrast, be directed a slight radial distance (on the order, for instance, of 1 mm) outside the spraying edge of the bell dish such that it impacts the coating material that needs to be or already is partially atomized by rotation. This causes a more intense constriction of the spray jet than that of the steering air emerging from the inner holes, such that the efficiency is maximized and small workpiece regions or workpiece regions that are difficult to access can also be adequately coated.

1. Method for controlling the width of the spray jet of an atomizer used in the series coating of workpieces, wherein the atomizing cone of the coating material being sprayed is bounded by a controllable gas current that annularly surrounds the atomizing cone and emerges from the atomizer concentric to the atomizing cone axis (3), characterized by the fact that at least two gas currents which can be controlled independently of one another are produced, wherein said gas currents are utilized as a function of the workpiece regions to be coated, and emerge at different radial distances from the atomizing cone axis (3).

2. Method according to claim 1, characterized by the fact that each gas current is controlled by a separate control circuit.

3. Method according to claim 1, characterized by the fact that a controlled gas current is supplied to the radially outer or the radially inner outlet openings (12,13), depending on the workpiece regions to be coated, by means of a controlled reversing valve.

4. Method according to one of the preceding claims, characterized by the fact that only one gas current is used for coating processes carried out with a wider atomizing cone, and by the fact that only the other gas current is used for coating processes carried out with a narrower atomizing cone.

5. Method according to claim 4, characterized by the fact that the two adjusting ranges of the width of the atomizing cone overlap one another.

6. Atomizer for the series coating of workpieces, with at least two annular arrangements of outlet openings (12,13) that concentrically surround the atomizing cone axis (3) at different radial distances, wherein said outlet openings face the atomizing cone and serve to produce a gas current that bounds the atomizing cone, and with a gas line arrangement that leads to the outlet openings (12,13) and is or can be connected to at least one control circuit for the gas current, characterized by the fact that the radially inner gas current and the radially outer gas current can be controlled independently of one another.

7. Atomizer according to claim 6, characterized by the fact that the radially inner arrangement of outlet openings (13) and the radially outer arrangement of outlet openings (12) are or can be respectively connected to a separate control circuit.

8. Atomizer according to claim 6, characterized by the fact that the supply line arrangement leading to the arrangements of outlet openings (12,13) is or can be connected to a common control circuit by means of a reversing valve.

9. Atomizer according to claim 8, characterized by the fact that the reversing valve is situated in the atomizer.

10. Atomizer according to one of claims 6-8, characterized by the fact that each arrangement of outlet openings (12,13) is connected to one gas connection of the atomizer for one respective external gas supply line.

11. Atomizer according to one of claims 6-10, characterized by the fact that the two arrangements of outlet openings (12,13) are situated in the end face (5) of an annular body (4) that faces the atomizing cone, wherein said annular body is mounted on the end face of the housing (2) that serves to hold the spraying head (1) of the atomizer and faces the atomizing cone.

12. Atomizer according to claim 11, characterized by the fact that the peripheral surface (7) of the annular body (4) is aligned flush with the adjacent peripheral surface (8) of the housing (2).
